(19) United States
(12) Patent Application Publication
(10) Pub. No.: US 2013/0277211 A1
(43) Pub. Date: Oct. 24, 2013

(54) REUSABLE SPRAY BOTTLE WITH INTEGRATED DISPENSER

(71) Applicant: Ceramatec, Inc., Salt Lake City, UT (US)

(72) Inventors: Ashok V. Joshi, Sandy, UT (US); Sai Bhavaraju, West Jordan, UT (US)

(21) Appl. No.: 13/856,908

(22) Filed: Apr. 4, 2013

Related U.S. Application Data
(60) Provisional application No. 61/623,640, filed on Apr. 13, 2012.

(51) Int. Cl. B05B 11/00; C25B 9/00

(52) U.S. Cl. CPC B05B 11/0081; C25B 9/00
USPC 204/275.1; 222/145.1

(57) ABSTRACT

An apparatus for cleaning and/or disinfecting surfaces and objects is disclosed herein. In one embodiment, such an apparatus includes a spray bottle that is refillable with water. A dispenser is integrated into the spray bottle to dispense a soluble material into the water to produce a solution. The soluble material includes at least one of a cleaning agent and a disinfecting agent. The soluble material is provided in a quantity sufficient to last several refills of the spray bottle.

### RELATED APPLICATIONS

This application claims priority to U.S. Provisional Patent No. 61/623,640 filed on Apr. 13, 2012 and entitled Reusable Spray Bottle with Integrated Dispenser, which application is incorporated herein by reference.

### FIELD OF THE INVENTION

This invention relates to apparatus and methods for cleaning and/or disinfecting surfaces and objects.

### BACKGROUND

The global market for cleaning and disinfecting products and equipment is large and growing, on the order of tens of billions of dollars every year. For example, the global market for industrial and institutional cleaning products is forecast to exceed $36.7 billion by the year 2015. The U.S. represents the largest regional market for industrial and institutional cleaning products, with Europe coming in second. Increased safety and health standards in the food and beverage, food service, and health care sectors, where hygienic environments are required, are driving growth for industrial and institutional cleaning products and equipment.

Currently, a wide range of products and equipment are available to clean and disinfect surfaces and objects in residential, industrial, commercial, hospital, hotel, food processing, and restaurant environments. Unfortunately, some of the best products and equipment for cleaning and disinfecting are confined to the commercial or industrial marketplaces due to their increased expense. That is, the small household user typically cannot afford or justify the expense associated with purchasing and maintaining commercial-quality cleaning products and equipment. Thus, although a substantial need exists for cleaning and disinfecting surfaces and objects in residential settings, typical household users may not have the best and most effective products and equipment at their disposal.

In view of the foregoing, what are needed are products and equipment for cleaning and/or disinfecting surfaces and objects in residential and other similar settings. Ideally, such products and equipment will provide results comparable to products and equipment used in industrial and/or commercial settings but without the associated costs. Further needed are products and equipment that are reusable many times without having to replenish the active agents used for cleaning and/or disinfecting. Yet further needed are water-based cleaners as opposed to solvent-based cleaners. Such water-based cleaners may reduce the environmental, safety, and health concerns associated with solvent-based cleaners.

### SUMMARY

The invention has been developed in response to the present state of the art and, in particular, in response to the problems and needs in the art that have not yet been fully solved by currently available apparatus and methods. Accordingly, the invention has been developed to provide apparatus and methods to clean and/or disinfect surfaces and objects. The features and advantages of the invention will become more fully apparent from the following description and appended claims, or may be learned by practice of the invention as set forth hereinafter.

Consistent with the foregoing, an apparatus for cleaning and/or disinfecting surfaces and objects is disclosed herein. In one embodiment, such an apparatus includes a spray bottle that is refillable with water. A dispenser is integrated into the spray bottle to dispense a soluble material into the water to produce a solution. The soluble material includes at least one of a cleaning agent and a disinfecting agent. The soluble material is provided in a quantity sufficient to last several refills of the spray bottle.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings in which:

FIG. 1 shows an embodiment of a spray bottle with an integrated dispenser, wherein the integrated dispenser is configured to dispense pellets or tablets into the spray bottle;

FIG. 2 shows an embodiment of a battery-powered electrolyzer incorporated into a spray bottle with an integrated dispenser;

FIG. 3 shows an embodiment of a generator-powered electrolyzer incorporated into a spray bottle with an integrated dispenser;

FIG. 4 shows an embodiment of a spray bottle with an integrated dispenser, wherein the integrated dispenser is configured to dispense a liquid or gel into the spray bottle;

FIGS. 5A and 5B show several examples of electrolyzers and exemplary input and output streams; and

FIG. 6 shows one embodiment of an electrochemical cell that may be used to produce “activated” water containing hydrogen peroxide.

### DETAILED DESCRIPTION OF THE INVENTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

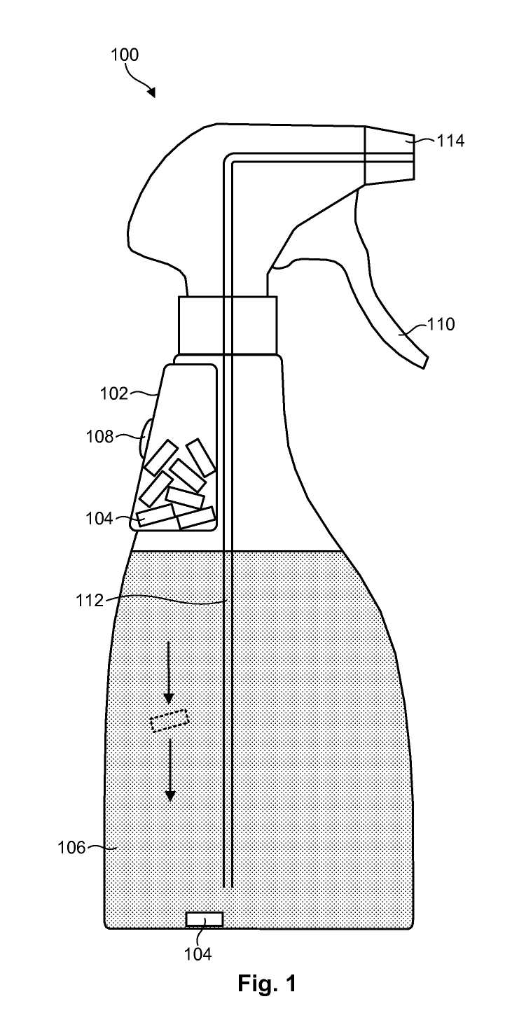

Referring to FIG. 1, one embodiment of a spray bottle 100 with integrated dispenser 102 is illustrated. In this embodiment, the integrated dispenser 102 is configured to dispense pellets 104 or tablets 104 into the spray bottle 100. These pellets 104 or tablets 104 may include a cleaning agent and/or disinfecting agent that dissolves in or mixes with water to form a solution 106. The solution 106 may have disinfecting/cleaning properties or have such properties after the solution is passed through an electrolyzer or an electrochemical cell. Embodiments of the spray bottle 100 comprising an electrolyzer and/or electrochemical cell will be discussed in more detail hereafter.

As shown, in certain embodiments, the integrated dispenser 102 may be configured to release pellets 104 or tablets 104 into the spray bottle 100 so that the pellets 104 or tablets 104 can dissolve in or mix with water. In certain embodiments, the integrated dispenser 102 includes a button 108 or other actuator to enable a user to release one or more pellets 104 or tablets 104 into the water. One benefit of this arrangement is that, when the solution 106 has been depleted, the user does not have to refill the spray bottle 100 with cleaning and/or disinfecting solution but rather only water. The pellets 104 or tablets 104 will be effective to convert the water into a cleaning and/or disinfecting solution 106. Furthermore, the integrated dispenser 102 may contain enough pellets 104 or tablets 104 for multiple refills of the spray bottle 100. Thus, the user will only need to have water at his or her disposal to refresh the spray bottle 100 with cleaning and/or disinfecting solution 106.

The pellets 104 or tablets 104 may contain various chemicals to provide desired disinfecting and/or cleaning properties. For example, in certain embodiments, the pellets 104 or tablets 104 contain one or more of soluble chlorites (e.g., metal chlorites), soluble hypochlorites (e.g., metal hypochlorites), soluble halides (e.g., metal halides), ammonium salts, or the like. Each of these compounds, when dissolved in or mixed with water, may produce solutions 106 having cleaning and/or disinfecting properties. For example, sodium hypochlorite, when dissolved in water, produces bleach, commonly used as a disinfectant or bleaching agent. Ammonium salts (e.g., ammonium carbonate) may dissolve in water to form a solution and, after passing the solution through an electrolyzer, produce ammonia which may be used as a general purpose cleaner for surfaces and objects.

As shown in FIG. 1, the spray bottle 100 includes a trigger-like actuator 110. Squeezing the trigger 110 actuates a pump (not shown), which draws the solution 106 into a tube 112 and expels the solution through a nozzle 114 onto a surface or object. The cleaning and/or disinfecting agent in the solution may lift dirt from the surface or object, and/or kill bacteria or other microorganisms residing on the surface or object.

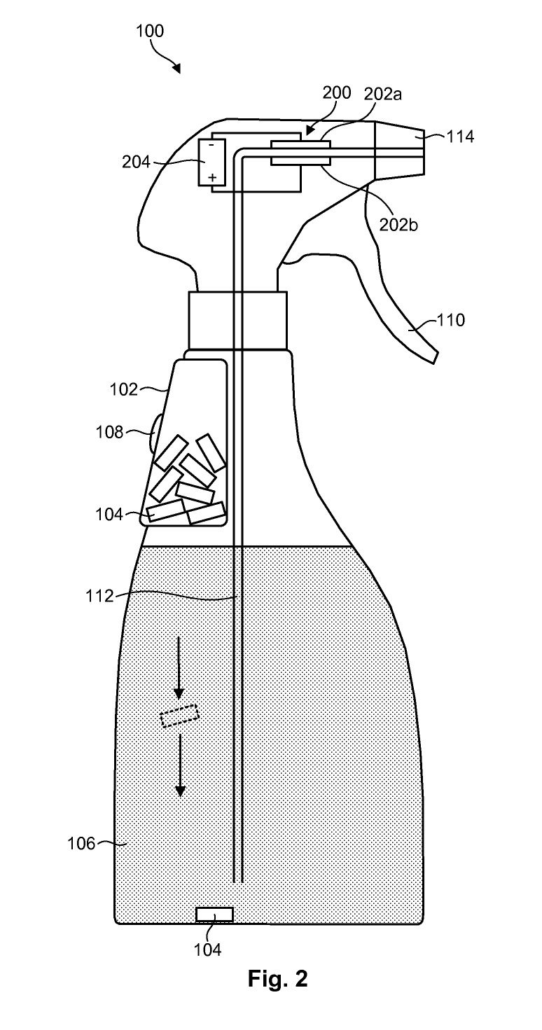

Referring to FIG. 2, as previously mentioned, in selected embodiments, the solution 106 in the spray bottle 100 may be passed through an electrolyzer 200 to electrolyze selected compounds in the solution 106. As shown, the electrolyzer 200 includes a pair of electrodes 202a, 202b. A negative electrode 202a attracts positive ions and a positive electrode 202b attracts negative ions. In the illustrated embodiment, a battery 204 creates a potential difference between the electrodes 202a, 202b, resulting in the passage of electrical current between the electrodes 202a, 202b. In certain embodiments, additional circuitry (not shown) is added to the electrolyzer 200 that only applies a potential difference across the electrodes 202a, 202b when the trigger 110 is actuated and the solution 106 is passed between the electrodes 202a, 202b, thereby preserving energy in the battery 204.

If, for example, the solution 106 is a sodium chloride (NaCl) solution, the electrolyzer 200 may disassociate the NaCL to produce sodium ions and chlorine gas by drawing sodium to the negative electrode 202a and chlorine to the positive electrode 202b. A fraction of the current may also be utilized to split water and thereby generate oxygen and hydrogen. The sodium will plate the negative electrode 202a, thereby leaving chlorine, a powerful disinfectant, in the exiting stream or spray. A chlorine evolving electrode may be used as the positive electrode 202b to generate chlorine. Examples of chlorine-evolving electrodes include Dimensionally Stable Anode (DSA), which is a mixture of ruthenium oxide, iridium oxide, and titanium oxide deposited on titanium metal. Chlorine is effective to kill bacteria or other organisms residing on a surface or object. The chlorine in the exiting stream or spray may also emit a scent that reassures a user that disinfection is taking place. Sodium chloride represents just one example of a compound that may be disassociated by the electrodes 202a, 202b and is not intended to be limiting.

By introducing ions and gases into the solution 106, the electrolyzer 200 is effective to convert the solution 106 into an electrochemically “activated” liquid. For the purposes of this disclosure, an electrochemically “activated” liquid is a liquid with elevated reactivity that contains (1) reactive species, and/or (2) meta-stable (activated) ions and free radicals formed after exposure to electrochemical energy in the form of a substantial voltage potential or current under non-equilibrium conditions. The term “activated” means, for example, the electrochemical or electrophysical state or condition of having excessive inner potential energy that is attained after exposure to thermodynamically non-equilibrium conditions for a period of time. Meta-stable ions and free radicals relax in time by undergoing a gradual transition from a meta-stable state to a state of thermo-dynamic equilibrium.

In the case of electrochemically activated water, the initial liquid source used to form electrochemically activated water may include, for example, (1) regular, untreated tap water or other water that is commonly available, (2) pure water to which one or more electrolytes have been added, (3) chemically treated tap water, and (4) other aqueous solutions containing a suitable concentration of electrolytes. Examples of suitable electrolytes include chloride salt, nitrate salt, carbonate salt, or any other salt that is soluble in water (or other liquid being electrochemically activated). Chloride salts include, for example, sodium chloride (such as pure NaCl), potassium chloride, magnesium chloride, calcium chloride, and the like. The term “electrolyte” means any substance that dissociates into two or more ions when dissolved in water or any substance that will conduct an electric current when in solution.

Electrochemically activated water has enhanced cleaning power and sanitation capability compared to non-electrochemically activated water. Electrochemically activated water also differs from regular or untreated water at the molecular level and electron level. It should also be noted that adding fine gas bubbles to electrochemically activated water creates a cleaning liquid that can efficiently wet a surface. If a reactive gas is used, such as oxygen, the oxygen gas bubbles can improve the wetting properties of the liquid by reducing the surface tension of the liquid and can be reactive to further enhance the cleaning and/or sanitizing properties of the liquid. The end result is an electrochemically activated foam, froth, or reactive gas with enhanced cleaning and/or sanitizing power.

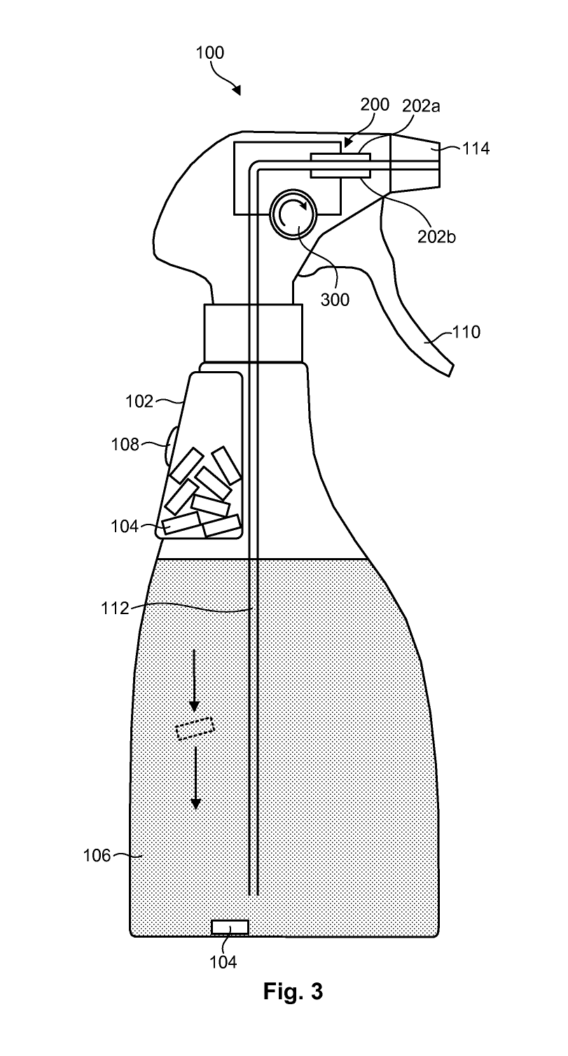

Referring to FIG. 3, in another embodiment, the electrolyzer 200 may be powered by a generator 300, such as a generator 300 actuated by the trigger 110. More particularly, actuating the trigger 110 may cause the generator 300 to spin and create electricity. In certain embodiments, a flywheel may be coupled to the generator 300 such that, when a user spins the generator 300, the flywheel will keep the generator 300 spinning for some designated period of time, such as a second or two. In other embodiments, the generator 300 may spin sufficiently without a flywheel. When a user squeezes the trigger 110, two actions may occur simultaneously: first, power will be supplied to the electrodes 202a, 202b, thereby splitting selected compounds in the solution 106; second, a pump is driven to produce a stream or spray, containing the disassociated ions, from the nozzle 114.

The spray bottle 100 of FIG. 3 is advantageous in that it does not require a battery 204 that may need to be periodically replaced or recharged. Furthermore, the generator 300 only produces power when needed—when the solution is being sprayed from the spray bottle 100. The trigger 110 converts a user's mechanical energy to the power needed to both spray and electrolyze the solution 106 simultaneously.

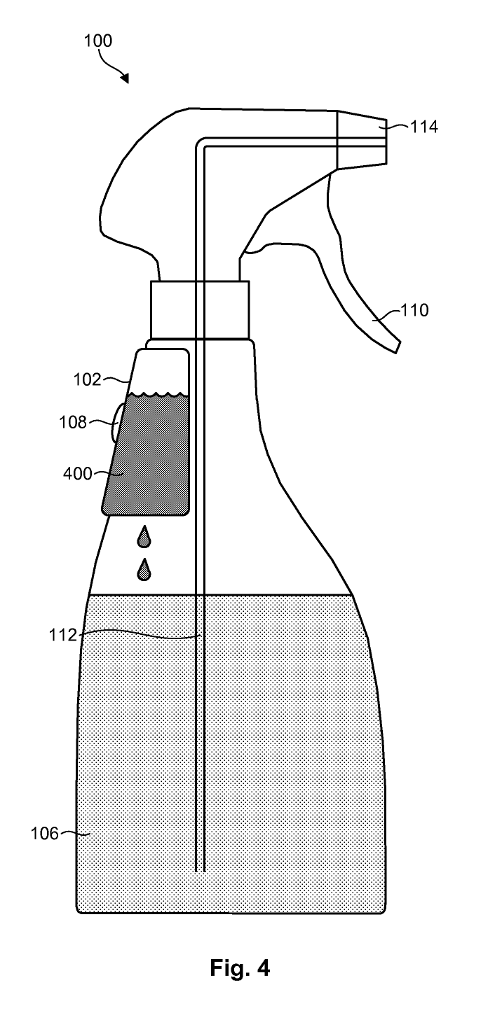

Referring to FIG. 4, in certain embodiments, instead of dispensing pellets 104 or tablets 104, the integrated dispenser 102 may be configured to dispense a liquid or gel into the spray bottle 100. The liquid or gel contains a cleaning agent and/or disinfecting agent that dissolves in or mixes with water to form a solution 106. The solution 106 may have disinfecting/cleaning properties, or have such properties after the solution 106 is passed through an electrolyzer 200 or an electrochemical cell, as previously discussed. In certain embodiments, pressing a button 108 on the integrated dispenser 102 will release one or more drops of the liquid 400 or gel 400 into the spray bottle 100.

In certain embodiments, the liquid 400 or gel 400 is a concentrated cleaning and/or disinfecting solution that becomes more dilute when it is released into a larger volume of water. The concentrated cleaning and/or disinfecting solution 400 may contain any of the chemicals discussed above with respect to FIG. 1. When the solution 106 is consumed, a user simply refills the spray bottle 100 with water and releases additional liquid 400 or gel 400 into the water, thereby producing additional cleaning/disinfecting solution 106. The integrated dispenser 102 may contain enough concentrated cleaning solution 400 for multiple refills of the spray bottle 100. Thus, like the previous example, the user will only need to have water at his or her disposal to replenish the spray bottle 100 with cleaning and/or disinfecting solution 106.

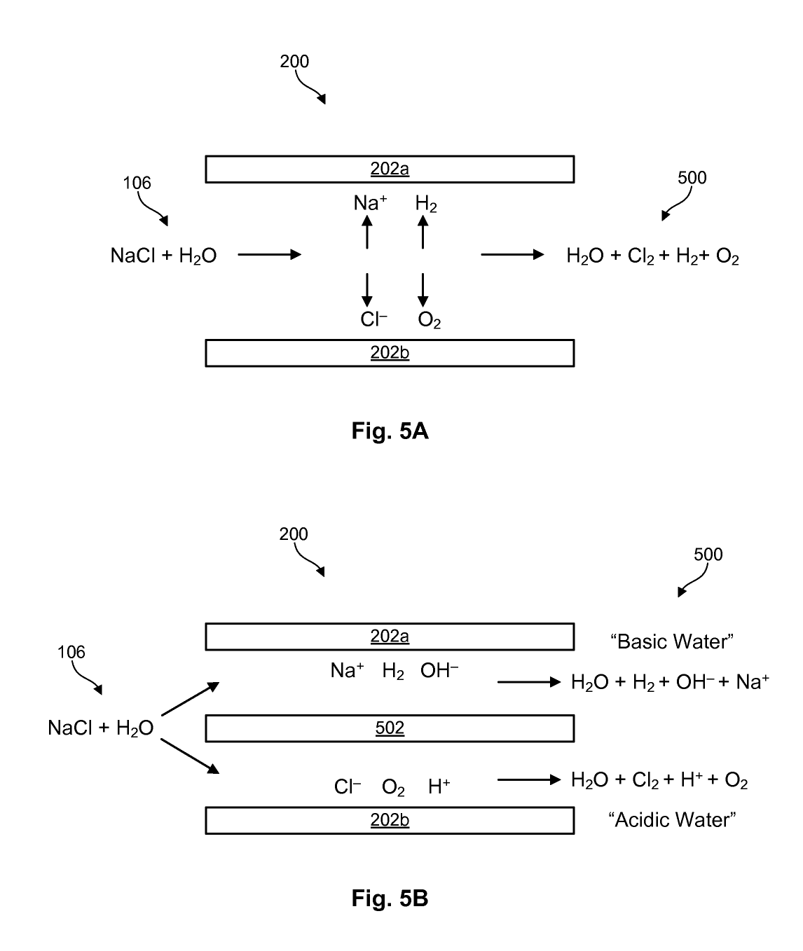

Referring to FIG. 5A, as discussed above, the cleaning and/or disinfecting solution 106 may, in certain embodiments, be passed through an electrolyzer 200 to create or enhance the cleaning and/or disinfecting properties of the solution 106. FIG. 5A shows one example of an electrolyzer 200 receiving a solution 106 of water and sodium chloride (NaCl). As shown, upon receiving the solution 106, the electrodes 202a, 202b decompose the sodium chloride compound. The negative electrode 202a attracts sodium ions (Na⁺) and the positive electrode 202b attracts chlorine ions (CY). The sodium plates the negative electrode 202a whereas the positive electrode 202b generates chlorine-based mixed oxidants. The chlorine-based mixed oxidants include predominantly chlorine gas (Cl₂), but also hypochlorite, chlorine dioxide, chlorate, perchlorate, and other oxidized chlorine-containing species, which leave the electrolyzer 200 in the exiting stream 500. In certain embodiments, the electrolyzer 200 may also decompose water in the solution 106 to generate some hydrogen, oxygen, and ozone gas in the exiting stream 500. When chlorine gas (Cl₂) combines with water in the exiting stream 500, a dilute mixture of hypochlorous acid (HOCl) and hydrochloric acid (HCl) may be generated in accordance with the following equation:

Cl₂+H₂O→HOCl+HCl

Both hypochlorous acid (HOCl) and hydrochloric acid (HCl) have antimicrobial properties and are used for cleaning and disinfecting. Any ozone generated also has disinfecting properties.

Referring to FIG. 5B, in certain embodiments, an ion-exchange membrane 502 may be present between the electrodes 202a, 202b to divide the cell 200 into anode and cathode compartments. If the ion-exchange membrane 502 is of anionic type, then it only allows anions to migrate from the negative electrode 202a to the positive electrode 202b. If the ion-exchange membrane 502 is of cationic type, then it only allows cations to migrate from the positive electrode 202b to the negative electrode 202a. Examples of cationic membranes 502 include NaSICON and Nafion® and examples of anionic membranes 502 include ACS (from Tokuyama corp., Japan) and AMI (from Membranes International). The advantage of this embodiment compared to the embodiment of FIG. 5A is that acidic water is generated in the anode compartment and basic water is generated in the cathode compartment. In the case where no membrane 502 is present the acidic and basic waters combine in the electrolyzer 200. The acidic and basic streams can be separately delivered to the area to be cleaned where they can combine. Thus water with more ions can be generated when a membrane 502 is present resulting in stronger cleaning and disinfecting action.

It should be recognized that the chemical reactions presented in FIGS. 5A and 5B are presented only by way of example and not limitation. The input stream 106 may contain different chemicals which may, in turn, produce different chemicals in the output stream 500. FIGS. 5A and 5B are simply shown to provide examples of how an electrolyzer 200 may be used to alter a solution 106 in a spray bottle 100 to enhance or change the disinfecting/cleaning properties of the solution 106.

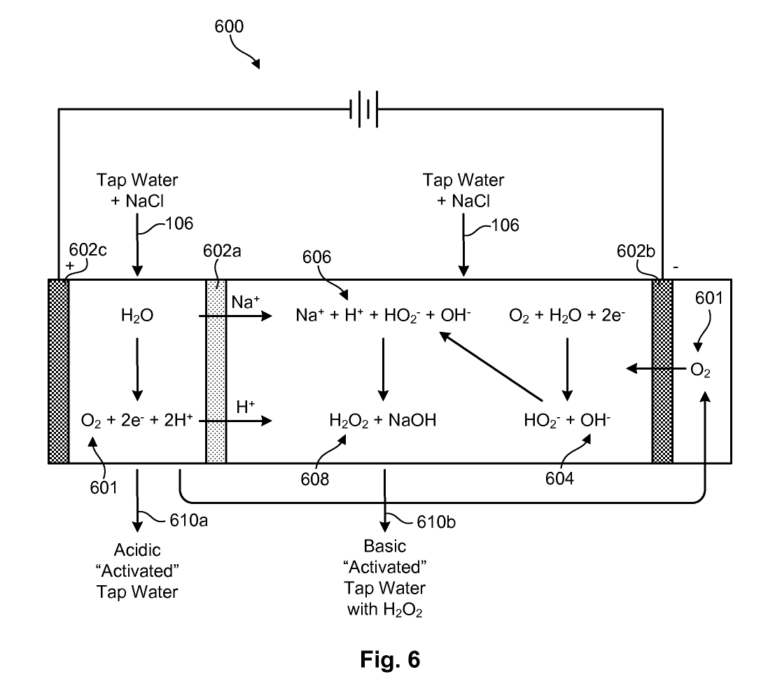

Referring to FIG. 6, one embodiment of an electrochemical cell 600 for producing “activated” water containing hydrogen peroxide is illustrated. Such an electrochemical cell 600 may be used in place of or in conjunction with the electrolyzer 200 previously described. The electrochemical cell 600 may also be considered an electrolyzer 200 for the purposes of the specification and claims.

FIG. 6 shows an electrochemical cell 600 that produces “activated” water which contains hydrogen peroxide, a well-known disinfectant. As shown, in one embodiment, the electrochemical cell 600 receives a solution 106 of tap water and sodium chloride. In certain embodiments, the tap water contains enough sodium chloride that no additional sodium chloride needs to be added. Upon receiving the tap water with sodium chloride, a water splitting reaction occurs at the anode 602c resulting in the generation of oxygen gas 601 and protons. Protons and sodium ions are transported through an ionically conductive membrane 602a. The oxygen gas 601 generated at the anode 602c is then transported to a Gas Diffusion Electrode (GDE) 602b (acting as a cathode 602b) where it reduces to form peroxide ions 604. The construction of a GDE is well known to those skilled in the art. The peroxide ions 604 then react with hydrogen ions 606 (which have been previously transported through the membrane 602a) to produce hydrogen peroxide 608 (H₂O₂). In this way, the electrochemical cell 600 produces two output streams 610a, 610b: (1) acidic “activated” tap water with chlorine-based mixed oxidants; and (2) basic “activated” tap water with hydrogen peroxide. These two output streams 610a, 610b may be independently or in combination sprayed from the spray bottle 100 to clean and disinfect a surface or object The present invention may be embodied in other specific forms without departing from its basic principles or essential characteristics. The described embodiments are to be considered in all respects as illustrative and not restrictive. The scope of the invention is, therefore, indicated by the appended claims rather than by the foregoing description. All changes which come within the meaning and range of equivalency of the claims are to be embraced within their scope.

1. An apparatus for cleaning and/or disinfecting surfaces and objects, the apparatus comprising:
a spray bottle that is refillable with water; and
a dispenser integrated into the spray bottle to dispense a soluble material into the water to produce a solution, the soluble material comprising one of a cleaning agent and a disinfecting agent, the soluble material provided in a quantity sufficient to last several refills of the spray bottle.

2. The apparatus of claim 1, wherein the soluble material comprises at least one of a soluble chlorite, a soluble hypochlorite, a soluble halide, and an ammonium salt.

3. The apparatus of claim 1, wherein the soluble material is provided in the form of a solid pellet.

4. The apparatus of claim 1, wherein the soluble material is provided in the form of a liquid.

5. The apparatus of claim 1, wherein the soluble material is provided in the form of a gel.

6. The apparatus of claim 1, wherein the spray bottle is configured to pass the solution through an electrolyzer to at least partially electrolyze the soluble material to produce sterilizing material.

7. The apparatus of claim 6, wherein the sterilizing material is a halogen.

8. The apparatus of claim 6, wherein the sterilizing material is ozone

9. The apparatus of claim 6, wherein the sterilizing material comprises halogen-based mixed oxidants comprising at least one of hypohalite, halogen dioxide, halide, and perhalide ions.

10. The apparatus of claim 6, wherein the electrolyzer is powered by a battery.

11. The apparatus of claim 6, wherein the electrolyzer is powered by a generator that is mechanically driven by a user.

12. The apparatus of claim 11, further comprising a user-driven actuator to simultaneously drive the generator and spray the solution from the spray bottle.

13. The apparatus of claim 6, wherein the electrolyzer is further configured to at least partially split water passing through the electrolyzer.

14. The apparatus of claim 6, wherein the electrolyzer is further configured to convert the water into “activated” water.

15. The apparatus of claim 14, wherein the “activated” water contains hydrogen peroxide.

16. The apparatus of claim 1, wherein the spray bottle outputs chlorinated water.

17. The apparatus of claim 16, wherein the spray bottle outputs chlorinated water.

18. The apparatus of claim 17, wherein the chlorinated water comprises at least one of the following chlorine-based mixed oxidants: hypochlorite, chlorine dioxide, chlorate, and perchlorate ions.

19. The apparatus of claim 1, wherein the soluble material further comprises a surfactant.
